(19) United States
(12) Patent Application Publication
(10) Pub. No.: US 2010/0086229 A1
(43) Pub. Date: Apr. 8, 2010

(54) Image signal processing apparatus and method

(75) Inventors: Young Sun JEON, Yongin-si (KR); Ho Jin LEE, Seoul (KR); Young Su MOON, Seoul (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 12/457,638

(22) Filed: Jun. 17, 2009

(30) Foreign Application Priority Data
Oct. 8, 2008 (KR) 10-2008-0098844

(51) Int. Cl. G06K 9/40

(52) U.S. Cl. 382/264

(57) ABSTRACT

An image signal processing method. A first coefficient indicating a probability that a first pixel of an input image is an edge may be calculated. A first edge enhanced signal where an edge of the input image is enhanced may be multiplied with the first coefficient, and a first low-pass filtered signal where the input image is low-pass filtered may be multiplied with a second coefficient indicating a probability that the first pixel is not an edge. The two calculated values may be added, and thus an edge enhanced signal may be generated.

### CROSS-REFERENCE TO RELATED APPLICATIONS

This application claims the benefit of Korean Patent Application No. 10-2008-0098844, filed on Oct. 8, 2008, in the Korean Intellectual Property Office, the disclosure of which is incorporated herein by reference.

### BACKGROUND

1. Field

Example embodiments relate to an image processing method, and more particularly, to an image processing method and apparatus that performs edge enhancement to improve the sharpness of an image.

2. Description of the Related Art

A method for improving image sharpness is the focus of significant attention in the area of image processing. Image sharpness may decrease due to hardware performance limitations, e.g., of an image device such as a digital camera or a scanner, camera movement or vibration during the image gathering process, and the like. A variety of signal processing technologies to increase sharpness exist.

One of the technologies for increasing sharpness is unsharp masking (USM), which may be applied to a digitally processed image signal as well as to an analog film processed image. First, low-pass filtering may be performed with respect to an original image to obtain a low-pass filtered image. Also, when a difference between the original image and the low-pass filtered image is calculated, a relatively high-pass filtered image may be obtained. A sharp image may be generated by multiplying the high-pass filtered image with a predetermined weight and adding the calculated value to the original image again.

By way of the above-described processes, image sharpness may be increased since an edge, which is a high frequency band, may be enhanced. However, noise, which has high frequency characteristics, may be enhanced as well.

### SUMMARY

Example embodiments may provide an image signal processing apparatus and method that may enhance an edge of an input image without enhancing noise.

Example embodiments may also provide an image signal processing apparatus and method, which may calculate a probability that a predetermined pixel is an edge pixel.

According to example embodiments, an image signal processing apparatus may be provided. The apparatus may include, for example, a first filter unit to low-pass filter an input signal and provide a first low-pass filtered signal a second filter unit to enhance a high frequency component of the input signal and provide a first edge enhanced signal a calculation unit to calculate a first coefficient indicating a probability that a first pixel is an edge pixel, the first pixel being associated with the input signal and a processing unit to provide an output signal determined as a linear sum of the first low-pass filtered signal and the first edge enhanced signal based on the first coefficient.

The second filter unit may provide the first edge enhanced signal obtained by multiplying a first value with a second coefficient and adding the calculated value to the input signal, the first value being determined based on a difference between the input signal and the first low-pass filtered signal.

The calculation unit may calculate a first feature value which is a difference between a maximum value and a minimum value by comparing values where the input signal is applied to N first edge detection filters, determine the first coefficient to be 1 when the first feature value is equal to or greater than a first threshold value, and determine the first coefficient to be a value between 0 and 1 in proportion to the first feature value when the first feature value is less than the first threshold value, each of the N first edge detection filters corresponding to a different direction, and N being a natural number equal to or greater than 1.

The N first edge detection filters, each corresponding to a different direction, may include a first horizontal edge detection filter and a first vertical edge detection filter, and the calculation unit may calculate a third feature value as a geometric mean of a first horizontal filtering value and a first vertical filtering value when the first feature value is equal to or greater than a first threshold value, determine the first coefficient to be 1 when the third feature value is equal to or greater than a third threshold value, and determine the first coefficient to be a value between 0 and 1 in proportion to the third feature value when the third feature value is less than the third threshold value, the first horizontal filtering value being calculated by applying the input signal to the first horizontal edge detection filter, and the first vertical filtering value being calculated by applying the input signal to the first vertical edge detection filter.

When the first feature value is less than the first threshold value, the calculation unit may calculate a second feature value which is a difference between a maximum value and a minimum value by comparing values where the input signal is applied to M second edge detection filters, determine the first coefficient to be 1 when the second feature value is equal to or greater than a second threshold value, and determine the first coefficient to be a value between 0 and 1 in proportion to the first feature value when the second feature value is less than the second threshold value, each of the M second edge detection filters corresponding to a different direction, and M being a natural number equal to or greater than 1.

The M second edge detection filters, each corresponding to a different direction, may include a second horizontal edge detection filter and a second vertical edge detection filter, and the calculation unit may calculate a fourth feature value as a geometric mean of a second horizontal filtering value and a second vertical filtering value when the second feature value is equal to or greater than a second threshold value, determine the first coefficient to be 1 when the fourth feature value is equal to or greater than a fourth threshold value, and determine the first coefficient to be a value between 0 and 1 in proportion to the fourth feature value when the fourth feature value is less than the fourth threshold value, the second horizontal filtering value being calculated by applying the input signal to the second horizontal edge detection filter, and the second vertical filtering value being calculated by applying the input signal to the second vertical edge detection filter.

The second filter unit may include a first high-pass filter to high-pass filter the input signal and provide a first high-pass filtered signal, and provide a first edge enhanced signal obtained by multiplying the first high-pass filtered signal with a second coefficient and adding the calculated value to the input signal.

According to other example embodiments, an image signal processing apparatus may be provided. The apparatus may include, for example, a first edge detection unit to calculate N filtering values by applying a first pixel of an input image to N first edge detection filters, each of the N first edge detection filters corresponding to a different direction, and N being a natural number equal to or greater than 1 and a calculation unit to calculate a first coefficient indicating a probability that the first pixel is an edge pixel based on the N filtering values.

The calculation unit may calculate a first feature value which is a difference between a maximum value and a minimum value from among the N filtering values, determine the first coefficient to be 1 when the first feature value is equal to or greater than a first threshold value, and determine the first coefficient to be a value between 0 and 1 in proportion to the first feature value when the first feature value is less than the first threshold value.

The N first edge detection filters, each corresponding to a different direction, may include a first horizontal edge detection filter and a first vertical edge detection filter, and the calculation unit may calculate a third feature value as a geometric mean of a first horizontal filtering value and a first vertical filtering value when the first feature value is equal to or greater than a first threshold value, determine the first coefficient to be 1 when the third feature value is equal to or greater than a third threshold value, and determine the first coefficient to be a value between 0 and 1 in proportion to the third feature value when the third feature value is less than the third threshold value, the first horizontal filtering value being calculated by applying the input image to the first horizontal edge detection filter, and the first vertical filtering value being calculated by applying the input image to the first vertical edge detection filter.

According to still other example embodiments, an image signal processing method may be provided. The method may include, for example, low-pass filtering an input signal and providing a first low-pass filtered signal enhancing a high frequency component of the input signal and providing a first edge enhanced signal calculating a first coefficient indicating a probability that a first pixel is an edge pixel, the first pixel being associated with the input signal and providing an output signal determined as a linear sum of the first low-pass filtered signal and the first edge enhanced signal based on the first coefficient.

The providing of the first edge enhanced signal may provide the first edge enhanced signal obtained by multiplying a first value with a second coefficient and adding the calculated value to the input signal, the first value being determined based on a difference between the input signal and the first low-pass filtered signal.

The calculating of the first coefficient may include calculating a first feature value which is a difference between a maximum value and a minimum value by comparing values where the input signal is applied to N first edge detection filters, each of the N first edge detection filters corresponding to a different direction, and N being a natural number equal to or greater than 1 and determining the first coefficient to be 1 when the first feature value is equal to or greater than a first threshold value, and determining the first coefficient to be a value between 0 and 1 in proportion to the first feature value when the first feature value is less than the first threshold value.

The calculating of the first coefficient may further include calculating a second feature value which is a difference between a maximum value and a minimum value by comparing values where the input signal is applied to M second edge detection filters, when the first feature value is less than the first threshold value, each of the M second edge detection filters corresponding to a different direction, and M being a natural number equal to or greater than 1 determining the first coefficient to be 1 when the second feature value is equal to or greater than a second threshold value and determining the first coefficient to be a value between 0 and 1 in proportion to the first feature value when the second feature value is less than the second threshold value.

Additional aspects, features, and/or advantages of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of example embodiments will become apparent and more readily appreciated from the following description, taken in conjunction with the accompanying drawings of which:

FIG. 1 is a block diagram illustrating an image signal processing apparatus according to example embodiments;

FIG. 2 is a diagram illustrating a second filter unit according to example embodiments;

FIG. 3 is a diagram illustrating a second filter unit according to other example embodiments;

FIG. 4 is a flowchart illustrating an operation of calculating a first coefficient in a calculation unit according to example embodiments;

FIG. 5 is a diagram illustrating an example of N first edge detection filters and M second edge detection filters of FIG. 4;

FIG. 6 is a diagram illustrating image processing operations according to example embodiments; and

FIG. 7 is a diagram illustrating an image signal processing apparatus that calculates a first coefficient α according to example embodiments.

### DETAILED DESCRIPTION

Reference will now be made in detail to example embodiments, examples of which are illustrated in the accompanying drawings, wherein like reference numerals refer to the like elements throughout. Example embodiments are described below to explain the present disclosure by referring to the figures.

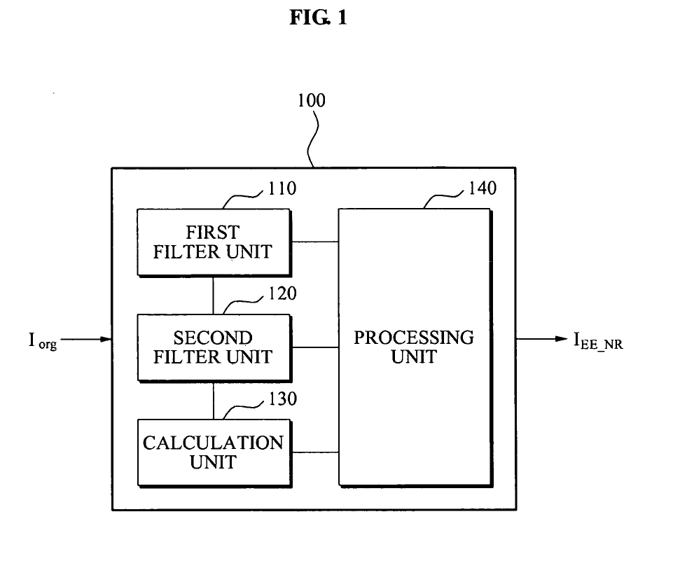

FIG. 1 is a block diagram illustrating an image signal processing apparatus 100 according to example embodiments.

The image signal processing apparatus 100 may include, for example, a first filter unit 110, a second filter unit 120, a calculation unit 130, and a processing unit 140.

The first filter unit 110 may provide the processing unit 140 with a low-pass filtered signal with respect to an input image. According to example embodiments, the first filter unit 110 may be a mean filter having a 3*3 size. However, the first filter unit 110 may be another type of filter that may provide an image where a low frequency component of the input image is enhanced. That is, the first filter unit 110 may not be limited to the example embodiment. Hereinafter, although the size of the filter is designated as 3*3, those skilled in the related art may control sensitivity or quality of image processing by varying the size of the filter.

The second filter unit 120 may provide the processing unit 140 with a first edge enhanced signal with respect to the input image. The second filter unit 120 may provide an image in which a high frequency component is enhanced with respect to the input image. According to example embodiments, the second filter unit 120 may include a high-pass filter. Also, the second filter unit 120 may provide the first edge enhanced signal obtained by multiplying a first high-pass filtered signal with a predetermined second coefficient λ and adding the multiplied value to an original signal of the input image. In this instance, the first high-pass filtered signal may be obtained by high-pass filtering the input image.

When a first pixel of the input image is an edge pixel of an original image, that is, the input image, a first pixel value of the first edge enhanced signal, for example, luminance, may increase. However, since a high frequency component of the image signal obtained through the second filter unit 120 may include an edge as well as a noise component, both edge and noise may be enhanced in the first edge enhanced signal. Accordingly, when only an edge may be selectively enhanced while excluding the noise, image processing quality may be improved.

According to other example embodiments, the second filter unit 120 may not include the high-pass filter. Here, alternatively, the second filter unit 120 may be provided with the first low-pass filtered signal from the first filter unit 110 or another low-pass filter, and may subtract the first low-pass filtered signal from the input image. Accordingly, the first high-pass filtered signal may be indirectly obtained.

The second filter unit 120 may be another type of filter that may enhance a high frequency band of the image signal. That is, the second filter unit 120 may not be limited to the example embodiment.

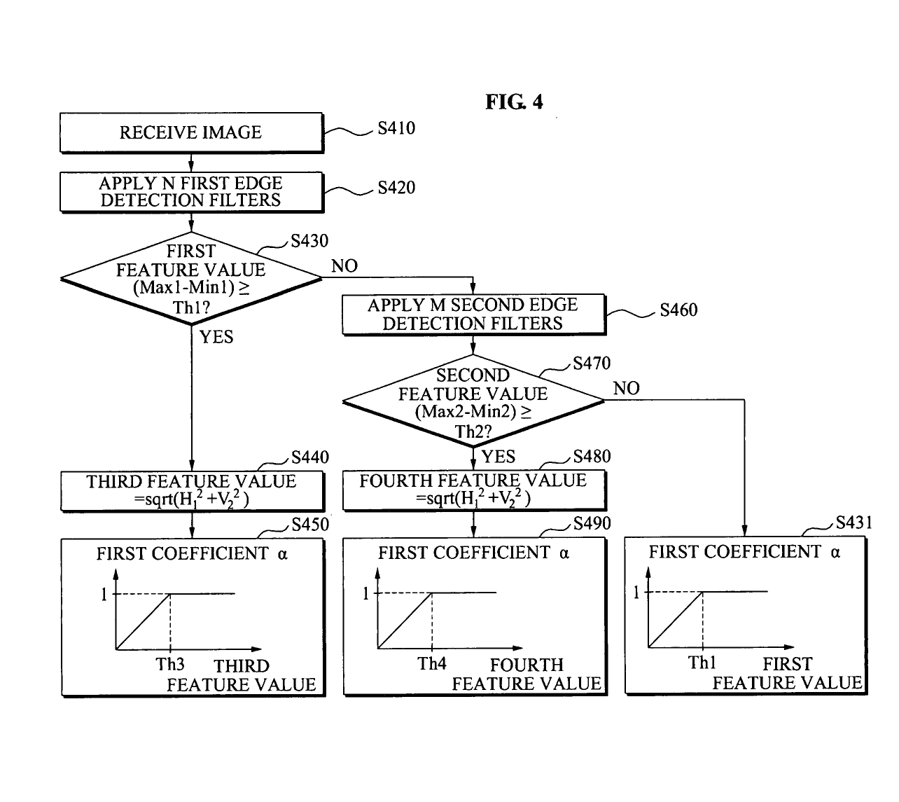

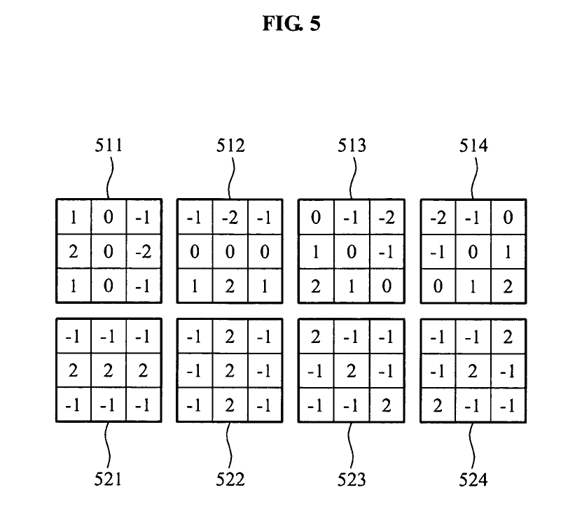

The calculation unit 130 may calculate a first coefficient indicating a probability that each pixel of the input image is an edge. The calculation unit 130 is described in greater detail with reference to FIGS. 4 and 5.

The processing unit 140 may provide an output signal determined as a linear sum of the first low-pass filtered signal and the first edge enhanced signal.

According to example embodiments, the processing unit 140 may provide the output signal determined by adding a value A and a value B. The value A may be obtained by multiplying the first coefficient with the first edge enhanced signal, and the value B may be obtained by multiplying the first low-pass filtered signal with a difference between 1 and the first coefficient.

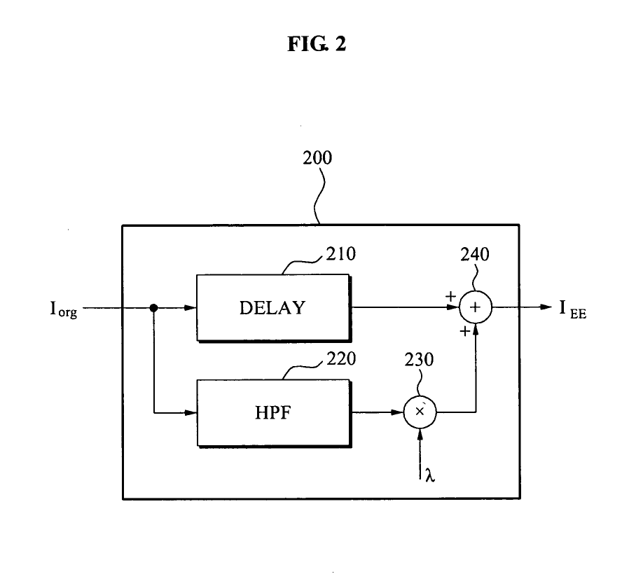

FIG. 2 is a diagram illustrating a second filter unit 200 according to example embodiments.

An input image I_{org} may be provided to a delay 210 and a first high-pass filter 220. A first high-pass filtered signal, which is an output of the first high-pass filter 220, may correspond to a high frequency component of the input image I_{org}. A multiplier 230 may multiply the first high-pass filtered signal with a second coefficient λ, and provide the calculated value to an adder 240. The adder 240 may add the input signal delayed in the delay 210 and an output of the multiplexer 230, and provide the calculated value as a first edge enhanced signal I_{EE}. Although the second coefficient λ is 1.5, according to example embodiments, the second coefficient λ may vary depending on the input image.

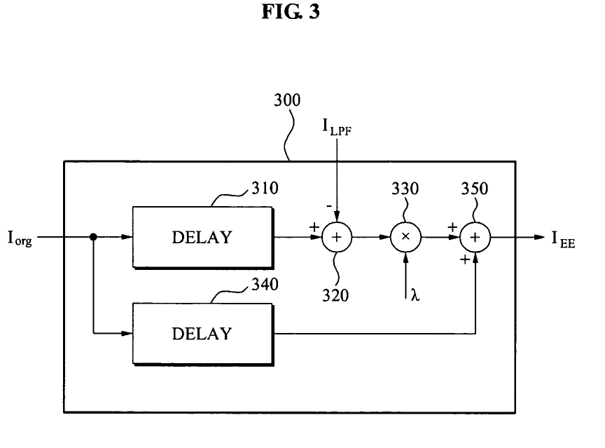

FIG. 3 is a diagram illustrating a second filter unit 300 according to other example embodiments.

An input image I_{org} may be provided to a delay 310. According to other example embodiments, a first low-pass filtered signal I_{LPF} may be provided from a first filter unit or another low-pass filter. The delay 310 may simply function as a delay for synchronization between the first low-pass filtered signal I_{LPF} and a signal of the input image I_{org}. A subtractor 320 may provide a multiplier 330 with a first value obtained by subtracting the first low-pass filtered signal I_{LPF} from the signal of the input image I_{org}. Also, the multiplier 330 may multiply the first value with a second coefficient λ, and provide the calculated value to an adder 350. The signal of the input image I_{org} may be provided to the adder 350 through a delay 340. The adder 350 may add the signal of the input image I_{org} to an output of the multiplier 330, and provide the calculated value as a first edge enhanced signal I_{EE}.

FIG. 4 is a flowchart illustrating an operation of calculating a first coefficient in a calculation unit 130 according to example embodiments.

In operation S410, an input image may be provided to the calculation unit 130. The input image may be a luminance value provided from a pre-processing unit (not shown).

In operation S420, each pixel of the input image may be applied to N first edge detection filters. In this instance, the N first edge detection filters may correspond to N directions, and N may be a natural number equal to or greater than 1. According to example embodiments, the N first edge detection filters may be four filters corresponding to a vertical direction, a horizontal direction, and two diagonal directions, and be associated with a Sobel edge detector.

N filtering values may be obtained by applying the input image to the N first edge detection filters.

In operation S430, a first feature value may be compared to a first threshold value, Th1. The first feature value may be a difference between a maximum value, Max 1, and a minimum value, Min 1, from among the N filtering values. The first feature value is in proportion to a directivity in the direction corresponding to Max 1.

The first threshold value may be changed to control the quality of image processing. That is, although the first threshold value is 40 according to example embodiments, the first threshold value may vary.

According to example embodiments, when the first feature value is equal to or greater than the first threshold value, a first coefficient may be determined to be 1. However, when a predetermined pixel, specifically, a first pixel of the input image is a gradient edge as opposed to an edge, the gradient edge may not be a portion desired to be enhanced, even though the first feature value is equal to or greater than the first threshold value, that is, although a directivity in any one direction is great. Here, the edge may indicate an edge line where a pixel value significantly changes.

Thus, according to example embodiments, in operation S440, a third feature value may be determined as a geometric mean of a first horizontal filtering value, H₁, and a first vertical filtering value, V₁, from among the N filtering values. In operation S450, when the third feature value is equal to or greater than a third threshold value, the first coefficient may be determined to be 1. When the third feature value is less than the third threshold value, the first coefficient may be determined to be a value between 0 and 1 in proportion to the third feature value, since the first pixel may be the gradient edge.

In operation S430, when the first feature value may be determined to be less than the first threshold value, the first coefficient may be determined to be a value between 0 and 1 in proportion to the first feature value.

However, it may not be determined that the first pixel is an edge, only since the first feature value is less than the first threshold value. Specifically, the first pixel may not be determined to be an edge because the Sobel edge detector may not detect a first line edge, which will be described below.

Thus, according to other example embodiments, in operation S460, M filtering values may be calculated by applying the first pixel to M second edge detection filters.

In operation S470, a second feature value may be compared to a second threshold value, Th2. The second feature value may be a difference between a maximum value, Max 2, and a minimum value, Min 2, from among the M filtering values. The second feature value may be equal to or greater than the second threshold value, since a directivity in a particular direction, associated with the maximum value, Max 2, is great. Although the second threshold value may be 60 as an example, the second threshold may vary as described above.

In operation S480, a fourth feature value may be determined as a geometric mean of a second horizontal filtering value, H₂, and a second vertical filtering value, V₂, to enhance only a real edge as opposed to the gradient edge.

In operation S490, when the fourth feature value is equal to or greater than a fourth threshold value, the first coefficient may be determined to be 1. When the fourth feature value is less than the fourth threshold value, the first coefficient may be determined to be a value between 0 and 1 in proportion to the fourth feature value, since the first pixel may be the gradient edge.

In operation S470, when the second feature value with respect to the first pixel may be less than the second threshold value, the first pixel may correspond to a portion with little directivity, and thereby be a noise portion as opposed to an edge portion. Thus, in operation S431, the first coefficient may be determined to be a value between 0 and 1 in proportion to the first feature value.

FIG. 5 is a diagram illustrating an example of the N first edge detection filters and the M second edge detection filters of FIG. 4.

A filter 511, a filter 512, a filter 513, and a filter 514 may be the first edge detection filters. The filter 511 may be a vertical filter of a Sobel edge detector, and the filter 512 may be a horizontal filter of the Sobel edge detector. The filter 513 and the filter 514 may be diagonal filters of the Sobel edge detector. Four filtering values for each pixel may be calculated by applying the input image to the filter 511, the filter 512, the filter 513, and the filter 514.

Although the Sobel edge detector may be efficient, the Sobel edge detector may not always detect a first line edge. For example, when a 3*3 matrix based on a first pixel value is [0, 0, 0; 255, 255, 255; 0, 0, 0], the first pixel may be a first horizontal line edge. Here, the first pixel value may be an object to be calculated. However, when applying the first pixel to the horizontal filter 512, a filtering value may be 0. Accordingly, a single filter may not appropriately detect an edge.

Any of a filter 521, a filter 522, a filter 523, and a filter 524 may be the second edge detection filters. The filter 521 may be a horizontal line edge detection filter, and the filter 522 may be a vertical line edge detection filter. The filter 523 and the filter 524 may be diagonal line edge detection filters. A configuration of the line edge detection filter may vary depending on circumstances.

Although the filters according to example embodiments are illustrated in FIG. 5, it may be apparent to those skilled in the related art that the first edge detection filters and the second edge detection filters may vary.

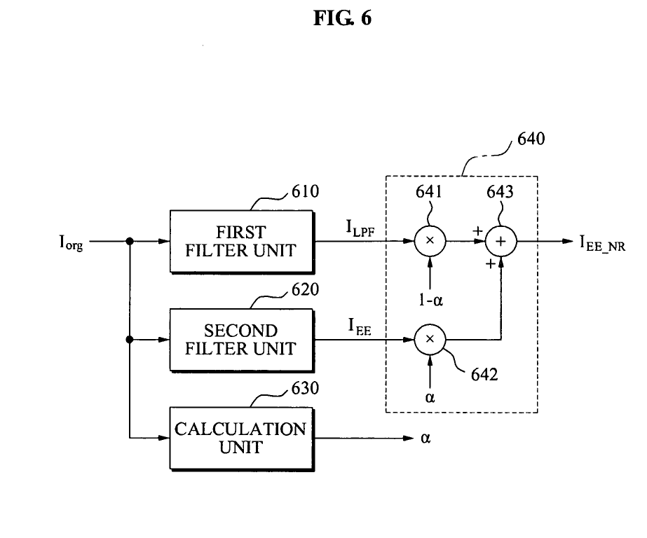

FIG. 6 is a diagram illustrating image signal processing operations according to example embodiments.

An input image may be provided to a first filter unit 610. The first filter unit 610 may provide a first low-pass filtered signal I_{LPF} to a multiplier 641 of a processing unit 640. Also, the multiplier 641 may multiply the first low-pass filtered signal I_{LPF} with (1−α), and provide the calculated value to an adder 643.

A second filter unit 620 may provide a first edge enhanced signal I_{EE} to a multiplier 642 of the processing unit 640. The multiplier 642 may multiply the first edge enhanced signal I_{EE} with a first coefficient α calculated by a calculation unit 630. Also, the multiplier 642 may provide the calculated value to the adder 643.

An output signal I_{EE}_{_{—}}_{NR} where a noise is removed and an edge is enhanced may be provided through an output of the adder 643.

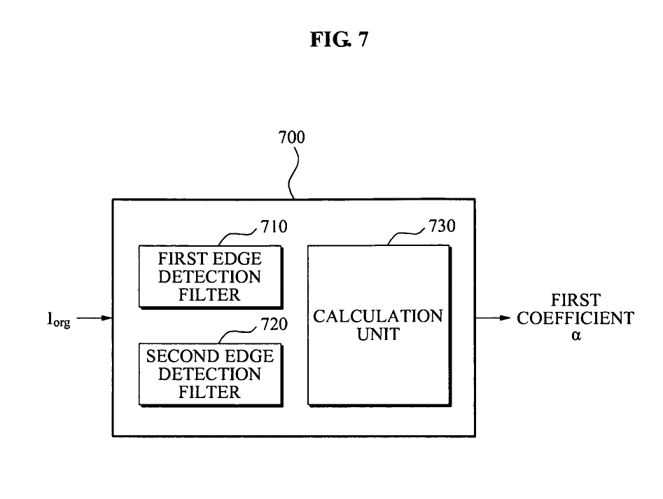

FIG. 7 is a diagram illustrating an image signal processing apparatus 700 that calculates a first coefficient α according to example embodiments.

When an input image I_{org} is received, a first edge detection filter 710 or a second edge detection filter 720, or both, of the image signal processing apparatus 700 may perform edge detection filtering with respect to the input image I_{org}. A calculation unit 730 may calculate and provide the first coefficient α based on a filtering value of the first edge detection filter 710 or a filtering value of the second edge detection filter 720, or both. The first coefficient α may indicate a probability that each pixel of the input image I_{org} is an edge. Here, an operation of each of the first edge detection filter 710, the second edge detection filter 720, and the calculation unit 730 may be understood with reference to example embodiments of FIG. 4 and FIG. 5.

The image signal processing method according to the above-described example embodiments may be recorded in computer-readable media including program instructions to implement various operations embodied by a computer. The media may also include, alone or in combination with the program instructions, data files, data structures, and the like. Examples of computer-readable media include: magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Examples of program instructions include both machine code, such as code produced by a compiler, and files containing higher level code that may be executed by the computer using an interpreter. The described hardware devices may be configured to act as one or more software modules in order to perform the operations of the above-described example embodiments, or vice versa. The software modules may be executed on any processor, general purpose computer, or special purpose computer including an image signal processing apparatus.

Although a few example embodiments have been shown and described, the present disclosure is not limited to the described example embodiments. Instead, it would be appreciated by those skilled in the art that changes may be made to these example embodiments without departing from the principles and spirit of the disclosure, the scope of which is defined by the claims and their equivalents.

What is claimed is:

1. An image signal processing apparatus, comprising:
a first filter unit to low-pass filter an input signal and provide a first low-pass filtered signal;
a second filter unit to enhance a high frequency component of the input signal and provide a first edge enhanced signal;
a calculation unit to calculate a first coefficient indicating a probability that a first pixel is an edge pixel, the first pixel being associated with the input signal; and
a processing unit to provide an output signal determined as a linear sum of the first low-pass filtered signal and the first edge enhanced signal based on the first coefficient.

2. The image signal processing apparatus of claim 1, wherein the second filter unit provides the first edge enhanced signal obtained by multiplying a first value with a second coefficient and adding the calculated value to the input signal, the first value being determined based on a difference between the input signal and the first low-pass filtered signal.

3. The image signal processing apparatus of claim 1, wherein the calculation unit calculates a first feature value which is a difference between a maximum value and a minimum value by comparing values where the input signal is applied to N first edge detection filters, determines the first coefficient to be 1 when the first feature value is equal to or greater than a first threshold value, and determines the first coefficient to be a value between 0 and 1 in proportion to the first feature value when the first feature value is less than the first threshold value, each of the N first edge detection filters corresponding to a different direction, and N being a natural number equal to or greater than 1.

4. The image signal processing apparatus of claim 3, wherein the N first edge detection filters, each corresponding to a different direction, comprise a first horizontal edge detection filter and a first vertical edge detection filter, and
the calculation unit calculates a third feature value as a geometric mean of a first horizontal filtering value and a first vertical filtering value when the first feature value is equal to or greater than a first threshold value, determines the first coefficient to be 1 when the third feature value is equal to or greater than a third threshold value, and determines the first coefficient to be a value between 0 and 1 in proportion to the third feature value when the third feature value is less than the third threshold value, the first horizontal filtering value being calculated by applying the input signal to the first horizontal edge detection filter, and the first vertical filtering value being calculated by applying the input signal to the first vertical edge detection filter.

5. The image signal processing apparatus of claim 3, wherein, when the first feature value is less than the first threshold value, the calculation unit calculates a second feature value, which is a difference between a maximum value and a minimum value, by comparing values where the input signal is applied to M second edge detection filters, determines the first coefficient to be 1 when the second feature value is equal to or greater than a second threshold value, and determines the first coefficient to be a value between 0 and 1 in proportion to the first feature value when the second feature value is less than the second threshold value, each of the M second edge detection filters corresponding to a different direction, and M being a natural number equal to or greater than 1.

6. The image signal processing apparatus of claim 5, wherein the M second edge detection filters, each corresponding to a different direction, comprises a second horizontal edge detection filter and a second vertical edge detection filter, and
the calculation unit calculates a fourth feature value as a geometric mean of a second horizontal filtering value and a second vertical filtering value when the second feature value is equal to or greater than a second threshold value, determines the first coefficient to be 1 when the fourth feature value is equal to or greater than a fourth threshold value, and determines the first coefficient to be a value between 0 and 1 in proportion to the fourth feature value when the fourth feature value is less than the fourth threshold value, the second horizontal filtering value being calculated by applying the input signal to the second horizontal edge detection filter, and the second vertical filtering value being calculated by applying the input signal to the second vertical edge detection filter.

7. The image signal processing apparatus of claim 1, wherein the second filter unit comprises a first high-pass filter to high pass-filter the input signal and provide a first high-pass filtered signal, and provides the first edge enhanced signal obtained by multiplying the first high-pass filtered signal with a second coefficient and adding the calculated value to the input signal.

8. An image signal processing apparatus, comprising:
a first edge detection unit to calculate N filtering values by applying a first pixel of an input image to N first edge detection filters, each of the N first edge detection filters corresponding to a different direction, and N being a natural number equal to or greater than 1; and
a calculation unit to calculate a first coefficient indicating a probability that the first pixel is an edge pixel based on the N filtering values.

9. The image signal processing apparatus of claim 8, wherein each of the N first edge detection filters is a Sobel edge detector.

10. The image signal processing apparatus of claim 8, wherein the calculation unit calculates a first feature value which is a difference between a maximum value and a minimum value from among the N filtering values, determines the first coefficient to be 1 when the first feature value is equal to or greater than a first threshold value, and determines the first coefficient to be a value between 0 and 1 in proportion to the first feature value when the first feature value is less than the first threshold value.

11. The image signal processing apparatus of claim 10, wherein the N first edge detection filters, each corresponding to a different direction, comprises a first horizontal edge detection filter and a first vertical edge detection filter, and
the calculation unit calculates a third feature value as a geometric mean of a first horizontal filtering value and a first vertical filtering value when the first feature value is equal to or greater than a first threshold value, determines the first coefficient to be 1 when the third feature value is equal to or greater than a third threshold value, and determines the first coefficient to be a value between 0 and 1 in proportion to the third feature value when the third feature value is less than the third threshold value, the first horizontal filtering value being calculated by applying the input image to the first horizontal edge detection filter, and the first vertical filtering value being calculated by applying the input image to the first vertical edge detection filter.

12. The image signal processing apparatus of claim 10, further comprising:
a second edge detection unit to calculate M filtering values by applying a first pixel of the input image to M second edge detection filters, when the first feature value is less than the first threshold value, each of the M second edge detection filters corresponding to a different direction, M being a natural number equal to or greater than 1,
wherein the calculation unit calculates a second feature value which is a difference between a maximum value and a minimum value from among the M filtering values, determines the first coefficient to be 1 when the second feature value is equal to or greater than a second threshold value, and determines the first coefficient to be a value between 0 and 1 in proportion to the first feature value when the second feature value is less than the second threshold value.

13. The image signal processing apparatus of claim 12, wherein the M second edge detection filters detects a first pixel line edge.

14. The image signal processing apparatus of claim 12, wherein the M second edge detection filters, each corresponding to a different direction, comprises a second horizontal edge detection filter and a second vertical edge detection filter, and
the calculation unit calculates a fourth feature value as a geometric mean of a second horizontal filtering value and a second vertical filtering value when the second feature value is equal to or greater than the second threshold value, determines the first coefficient to be 1 when the fourth feature value is equal to or greater than a fourth threshold value, and determines the first coefficient to be a value between 0 and 1 in proportion to the fourth feature value when the fourth feature value is less than the fourth threshold value, the second horizontal filtering value being calculated by applying the input image to the second horizontal edge detection filter, and the second vertical filtering value being calculated by applying the input image to the second vertical edge detection filter.

15. An image signal processing method, comprising:
low-pass filtering an input signal and providing a first low-pass filtered signal;
enhancing a high frequency component of the input signal and providing a first edge enhanced signal;
calculating, on a computer, a first coefficient indicating a probability that a first pixel is an edge pixel, the first pixel being associated with the input signal; and
providing, from the computer, an output signal determined as a linear sum of the first low-pass filtered signal and the first edge enhanced signal based on the first coefficient.

16. The image signal processing method of claim 15, wherein the providing of the first edge enhanced signal provides the first edge enhanced signal obtained by multiplying a first value with a second coefficient and adding the calculated value to the input signal, the first value being determined based on a difference between the input signal and the first low-pass filtered signal.

17. The image signal processing method of claim 15, wherein the calculating of the first coefficient comprises:
calculating a first feature value which is a difference between a maximum value and a minimum value by comparing values where the input signal is applied to N first edge detection filters, each of the N first edge detection filters corresponding to a different direction, and N being a natural number equal to or greater than 1; and
determining the first coefficient to be 1 when the first feature value is equal to or greater than a first threshold value, and determining the first coefficient to be a value between 0 and 1 in proportion to the first feature value when the first feature value is less than the first threshold value.

18. The image signal processing method of claim 17, wherein the N first edge detection filters, each corresponding to a different direction, comprise a first horizontal edge detection filter and a first vertical edge detection filter, and
the calculating of the first coefficient comprises:
calculating a third feature value as a geometric mean of a first horizontal filtering value and a first vertical filtering value when the first feature value is equal to or greater than a first threshold value, the first horizontal filtering value being calculated by applying the input signal to the first horizontal edge detection filter, the first vertical filtering value being calculated by applying the input signal to the first vertical edge detection filter; and
determining the first coefficient to be a value between 0 and 1 in proportion to the third feature value when the third feature value is less than the third threshold value.

19. The image signal processing method of claim 17, wherein the calculating of the first coefficient further comprises:
calculating a second feature value which is a difference between a maximum value and a minimum value by comparing values where the input signal is applied to M second edge detection filters, when the first feature value is less than the first threshold value, each of the M second edge detection filters corresponding to a different direction, and M being a natural number equal to or greater than 1;
determining the first coefficient to be 1 when the second feature value is equal to or greater than a second threshold value; and
determining the first coefficient to be a value between 0 and 1 in proportion to the first feature value when the second feature value is less than the second threshold value.

20. The image signal processing method of claim 19, wherein the M second edge detection filters, each corresponding to a different direction, comprises a second horizontal edge detection filter and a second vertical edge detection filter, and
the calculating of the first coefficient further comprises:
calculating a fourth feature value as a geometric mean of a second horizontal filtering value and a second vertical filtering value when the second feature value is equal to or greater than a second threshold value, the second horizontal filtering value being calculated by applying the input signal to the second horizontal edge detection filter, the second vertical filtering value being calculated by applying the input signal to the second vertical edge detection filter; and
determining the first coefficient to be a value between 0 and 1 in proportion to the second feature value when the fourth feature value is less than the fourth threshold value.

21. A computer-readable recording medium storing computer readable code comprising instructions for implementing an image signal processing method, the method comprising:
low-pass filtering an input signal and providing a first low-pass filtered signal;
enhancing a high frequency component of the input signal and providing a first edge enhanced signal;
calculating a first coefficient indicating a probability that a first pixel is an edge pixel, the first pixel being associated with the input signal; and
providing an output signal determined as a linear sum of the first low-pass filtered signal and the first edge enhanced signal based on the first coefficient.
